(19) United States
(12) Patent Application Publication
(10) Pub. No.: US 2024/0064223 A1
(43) Pub. Date: Feb. 22, 2024

(54) PHONE ACCESSORY

(71) Applicant: Lifetime Brands, Inc., Garden City, NY (US)

(72) Inventors: John Roscoe Swartz, Ridgewood, NJ (US); Dana Kirschenbaum-Stanley, Astoria, NY (US)

(21) Appl. No.: 17/820,615

(22) Filed: Aug. 18, 2022

(51) Int. Cl. H04M 1/04

(52) U.S. Cl. CPC H04M 1/04

(57) ABSTRACT

A smartphone accessory is configured to slide over a vertical support surface and enable a user to maintain support of the smartphone while being able to use the same. The smartphone accessory is a unitary structure and includes a substantially vertical front support, a lower support extending transversely from the front support, and a rear support connected to the front support by a bend in the unitary structure. The bend forms a space between the front support and rear support.

### BACKGROUND

### Technical Field

The present invention relates to a cell phone accessory. More particularly, it relates to a phone accessory configured to be removably attached or hung onto a substantially vertical surface, such as a wall of a backpack.

### Description of Related Art

The use of backpacks and other carrying devices has become commonplace with the dawn of remote working and remote work environments. With such remote work situations, there is a need to support a smart phone in a manner that makes it both accessible and usable at the same time. The present invention provides an accessory for a smartphone that solves this problem.

### SUMMARY OF THE INVENTION

This and other aspects of the invention are achieved by a smartphone accessory having a unitary structure that includes a substantially vertical front support, a lower support extending transversely from the front support, and a rear support connected to the front support by a bend in the unitary structure.

The smartphone accessory further includes a space formed between the front support and the rear support. The space is configured to be received by a vertical support surface.

The lower support further includes a notch configured to allow the smartphone to be connected to a wire while positioned on the lower support.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a perspective view of the phone accessory according to a first embodiment of the invention;

FIG. 2 a perspective view of the phone accessory as attached to another device, according to a further implementation of the invention;

FIGS. 3 and 4 show the phone accessory in operation as attached to another device, according to yet another implementation of the invention.

### DETAILED DESCRIPTION

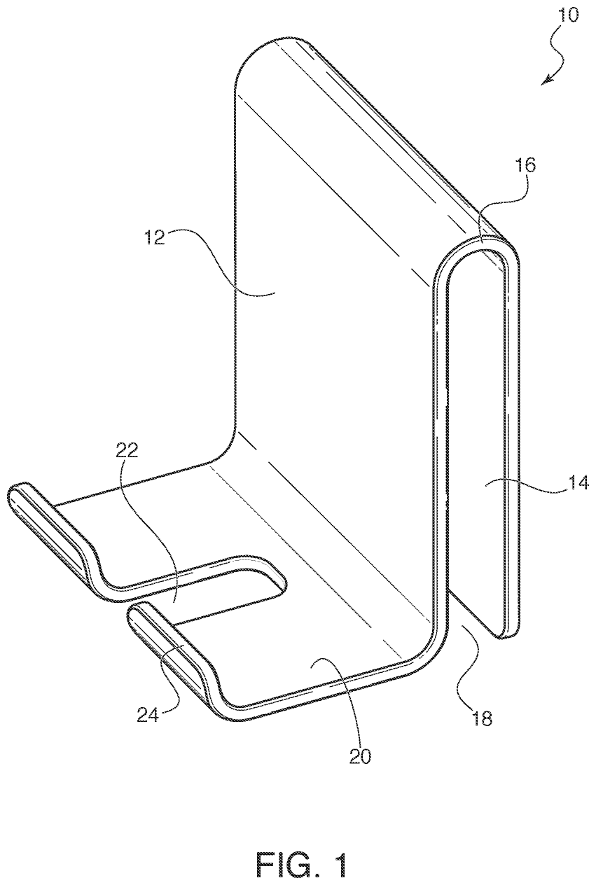

FIG. 1 shows the phone accessory 10 according to a preferred implementation of the present invention. Accessory 10 is a unitary structure/piece and includes a substantially flat and vertical front support/surface 12 having a horizontal phone support 20 extending from the bottom of the front surface. The phone support 20 extends substantially transverse to the front surface 12 and includes a notch 22 that is centered in the support 20. The distal ends of the phone support surface 20 can include upward extensions 24 which operate to hold/support the bottom of a smartphone.

The unitary structure of the phone accessory 10 can be achieved using any type of material suitable for the same. Examples of such materials include plastics, metals, or even a combination of the same.

The front support surface 12 is integrated with the rear support 14 through a bend 16 in the unitary structure. The rear support 14 is substantially parallel to the front surface 12 so as to create a space 18 between the rear support and the front surface.

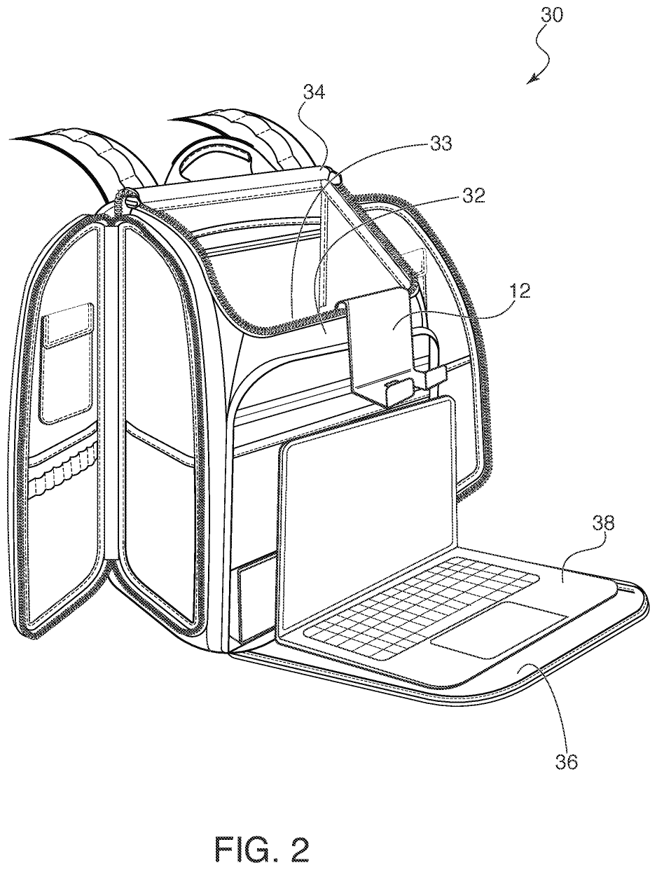

Referring now to FIGS. 2-4, the use of the phone accessory 10 is described in the context of a backpack or the like used by, for example, a remote worker. In this exemplary embodiment, the backpack 30 has a front, substantially vertical surface 32 such that when the top panel 34 is unzipped, the top 33 of the vertical surface 32 is exposed. As will be apparent, the phone accessory is positioned over the vertical surface 32 such it is received into the space 18 formed by the front surface 12 and the rear support 14 (See FIG. 2). In this manner, the phone accessory is maintained in place by bend portion 16 resting on the top 33 of the vertical surface 32. It will be appreciated that the vertical surface or support 32 can be any substantially vertical portion of a bag or the like that slides into the space 18 of the phone accessory 10.

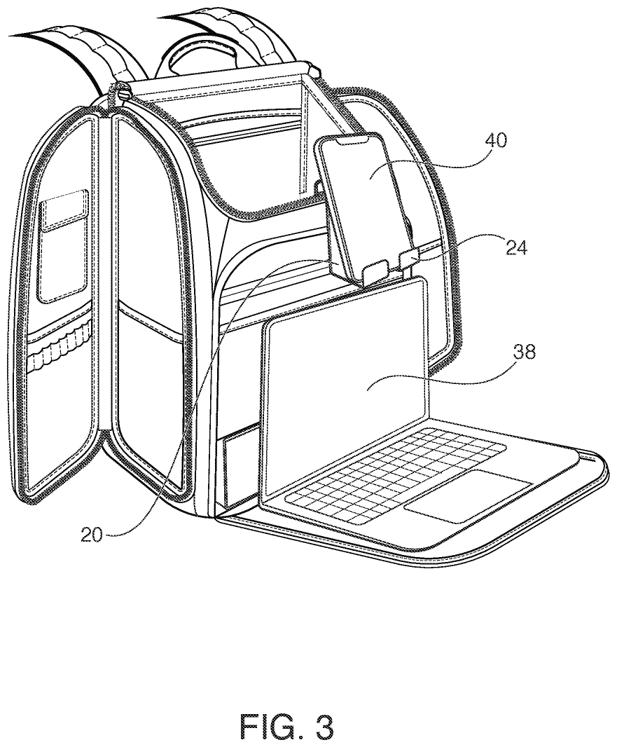

As shown, the backpack has a front panel 36 that when open, a laptop or the like 38 can be positioned on the same. The phone accessory 10 is configured to position a smartphone 40 on the support surface 20 such that the same is positioned directly above the laptop and does not interfere with the use of the same (See FIG. 3). In this embodiment, it can be seen how the upward extensions 24 support the phone at the angled disposition shown.

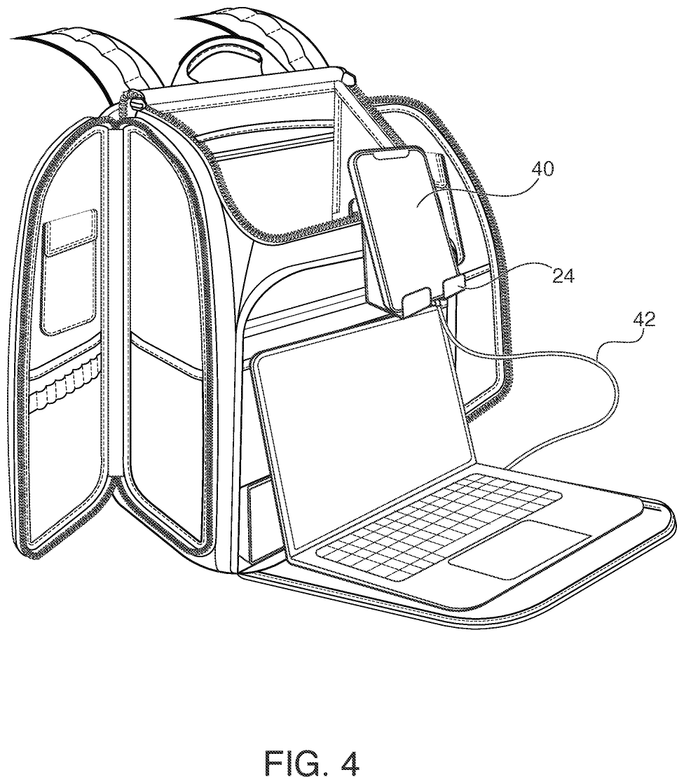

As shown in FIG. 4, the slot or space 22 in the horizontal support 20 is configured to allow the user to connect their charging or USB wire 42 to the same while avoiding interference with the operation of the phone accessory and/or the user's laptop positioned beneath the same.

In another alternative embodiment, the bend 16 in the top of the accessory can be configured such that rear support 14 bends or is biased toward the front surface 12 in a less than parallel configuration. In this manner, the flexibility in the material used to make the phone accessory can enable the rear support to operate more like a clip and add to the frictional engagement with the vertical surface onto which the phone accessory is positioned.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the invention as defined in the appended claims.

What is claimed is:

1. A smartphone accessory comprising:
a unitary structure having:
a substantially vertical front support,
a lower support extending transversely from the front support, and
a rear support connected to the front support by a bend in the unitary structure.

2. The smartphone accessory according to claim 1, further comprising a space formed between the front support and the rear support, said space configured to be received by a vertical support surface.

3. The smartphone accessory according to claim 1, wherein the lower support further comprises a notch configured to allow the smartphone to be connected to a wire while positioned on the lower support.

4. A smartphone accessory comprising:
a unitary structure having:
a substantially vertical front support,
a horizontal lower support extending transversely from the front support and having a notch centrally disposed therein,
a rear support connected to the front support by a bend in the unitary structure,
a space formed between the front support and the rear support, said space configured to be received by a vertical support surface.

5. The smartphone accessory according to claim 4, wherein the front support and the rear support are substantially parallel to each other.
